(19) United States
(12) Patent Application Publication
(10) Pub. No.: US 2017/0308678 A1
(43) Pub. Date: Oct. 26, 2017

(54) DISEASE PREDICTION SYSTEM USING OPEN SOURCE DATA

(71) Applicant: HRL Laboratories, LLC, Malibu, CA (US)

(72) Inventors: Sofia Apreleva, Santa Monica, CA (US); Tsai-Ching Lu, Thousand Oaks, CA (US)

(21) Appl. No.: 14/626,224

(22) Filed: Feb. 19, 2015

Related U.S. Application Data
(60) Provisional application No. 61/941,920, filed on Feb. 19, 2014.

(51) Int. Cl. G06F 19/00; G06N 99/00

(52) U.S. Cl. CPC G06F 19/3493; G06N 99/005

(57) ABSTRACT

Described is a disease prediction system using open source data. The system includes a preprocessing module, a learning module, and a prediction module. The preprocessing module receives a dataset of N trend results related to a disease event and generates an enhanced filter signal (EFS) curve related to the disease event. The learning module receives the EFS curve and generates a predicted number of cases of the disease event and, using a plurality of machine learning methods, generates a plurality of predictions that the disease event will happen within a future time period. The prediction module determines precision and recall for each of the plurality of predictions and, based on the precision and recall, provides a likelihood that the disease event will occur.

### CROSS-REFERENCE TO RELATED APPLICATIONS

The present application is a non-provisional patent application, claiming the benefit of priority of U.S. Provisional Application No. 61/941,920, filed on Feb. 19, 2014, entitled, “Predict Rare Disease Using Open Source Data.”

### GOVERNMENT RIGHTS

This invention was made with government support under U.S. Government Contract IARPA OSI-D12PC00285. The government have certain rights in the invention.

### BACKGROUND OF THE INVENTION

### (1) Field of Invention

The present invention relates to a prediction system and, more particularly, to a system for predicting disease using open source data.

### (2) Description of Related Art

The prevention of infectious diseases and timely health threat detection are a global health priority task. Early detection of disease activity, when followed by a rapid response, can reduce both social and medical impact of the disease, so it is an important defend the line against infectious disease. However, conventional surveillance systems (e.g., the Centers for Disease Control and Prevention (CDC)) rely on clinical data. The CDC publishes the surveillance results weeks after epidemic outbreaks, so there is a need for an early alerting system which could inform outbreak before the wide spread of disease.

There are many generative approaches which provide insight into mechanisms of dynamics of disease spreading. These models capture aspects of disease spreading at different levels: from within-host (intracellular) influenza dynamics with and without immune responses (see the List of Incorporated Literature References, Literature Reference No. 14) to human behaviors (between-host dynamics) (see Literature Reference No. 15). These models are based on the solution to ordinary differential equations with different kinetic parameters. More sophisticated models include population scale and taking into account spatial information. Some models tends to unite models at different scales with historical data (see Literature Reference No. 3). Good review of existing approaches can be found in Literature Reference No. 16. Statistical models, for example, are mostly related to the correlation of seasonal weather changes or other environmental factors with disease activity (see Literature Reference Nos. 17-19).

The need of early alerts and disease treat detection led to the development of epidemic intelligence (see Literature Reference No. 20) (ProMED-mail is the first example of such a system). Epidemic intelligence consists of the ad hoc detection and interpretation of unstructured information available in the Internet. This information is generated by official and informal types of sources, and may include rumors from the media or more reliable information from official sources or traditional epidemiological surveillance systems. Epidemic intelligence is a complex process that includes a formalized protocol for event selection, verification of the genuineness of reported events, searches of complementary reliable information, analysis and communication.

Surveillance based on web search volumes became another promising tool providing timely alerts about disease outbreaks. A vivid illustration of successful influenza-like illness (ILI forecasting based on web search queries are Google Flu Trends, an approach, method and examples of such applications are presented in Literature Reference No. 1. A number of papers describe successful application of Google Flu trends for monitoring the level of ILI activities, which provides the estimation of trends of disease level well ahead of officially reported statistics (see Literature Reference Nos. 2, 4, and 21-23).

Prediction methods presented in the literature relate web search queries with statistics available in official reports of diseases activity level. The model's parameters are generally estimated based on training data, and used for forecasting assuming slow changes in values of these parameters with time or during the period of interest.

There are two types of signals extracted from web search trends: one is formed by time series of volumes of searches (see Literature Reference Nos. 6, 8, and 12) and the other is a fraction of disease related searches from the total number of searches made per day or a week (see Literature Reference Nos. 1 and 5). The first type of data is correlated with a number of confirmed cases of disease, whereas the second type of data is correlated with a fraction of disease related visits to a doctor, rate of mortality caused by the illness, etc.

Web search terms usually include the names, causes, symptoms, diagnosis methods, treatment and related diseases (see, for example, Literature Reference No. 12). High linear correlation of separate web search queries of disease related terms with a morbidity trend is observed and directly used by many researchers for forecasting (see, for example, Literature Reference Nos. 6 and 24). Such data is commonly used by researchers for influenza like diseases which can be explained by a large percentage of population prone to influenza. Linear fit between log it function (log-odds) of fraction of queries and fraction of official records related to the disease under study is used by the author in Literature Reference Nos. 1 and 11. In Literature Reference No. 1, for example, the authors present a system which chose among 50,000 terms the time series with highest correlation and summed the top terms to achieve better prediction results. Alternatively and as described in Literature Reference No. 11, the author investigates the possibility of monitoring of scarlet fever in the United Kingdom and showed that gamma transformation of time series of interest shows better prediction as compare to logit transformation, especially for queries which weakly correlated with disease level.

Most of the modifiable infectious diseases, with less infections and searches, do not have a high correlation between the disease trends and related search volume trends (see, for example, Literature Reference No. 12). In this case, other methods are employed such as Hidden Markov Models (HMM) (see, for example, Literature Reference No. 7 and 12) for tuberculosis and hepatitis studies; decision trees (see Literature Reference No. 10) and Support Vector Machines (see literature Reference No. 8) for dengue fever surveillance.

Thus, a continuing need exists for a system that is efficient and effectively predicts diseases (where there is a low-correlation between disease trends and related search volume trends) to provide an early alert system that informs of an outbreak before widespread of disease.

### SUMMARY OF INVENTION

The present invention relates to a system for predicting disease using open source data. The system includes a preprocessing module operable for receiving a dataset of N trend results related to a disease event and generating an enhanced filter signal (EFS) curve related to the disease event. Also included is a learning module that is operable for receiving the EFS curve and generating a predicted number of cases of the disease event and, using a plurality of machine learning methods, generating a plurality of predictions that the disease event will happen within a future time period. Further, the system include a prediction module that is operable for determining precision and recall for each of the plurality of predictions and, based on the precision and recall, providing a likelihood that the disease event will occur.

In another aspect, in generating the EFS curve, the preprocessing module further performs operations of detrending, scaling, and filtering the dataset to remove signals unrelated to occurrences of the searched disease event.

In yet another aspect, in filtering the dataset, the dataset is filtered with a threshold for a Pearson coefficient.

Further, in filtering the dataset, the preprocessing module determines the threshold for a Pearson coefficient by performing operations of: generating a same number of random time series as in the dataset of N trend results; if the dataset of N trend results contains M points, randomly picking a number in a range from 0 to 100 M times so that a length of each time series is the same; calculating a maximum Pearson Correlation coefficient R between a ground truth and each of a random trend; repeating the operations of generating, randomly picking, and calculating a predetermined number of times; and filtering the dataset of N trend results such that a mean of the distribution of R is a threshold Tᵣ used for dataset filtering, such that only time series which have R>Tᵣ are summed together and form the EFS.

In another aspect, in providing a likelihood that the disease event will occur, the prediction amongst the plurality of predictions that provides a best precision/recall pair is selected as the likelihood that the disease event will occur.

In yet another aspect, generating a predicted number of cases of the disease event further comprises an operation of performing linear regression on the EFS curve with a sliding window that is adjusted ahead a predetermined time period.

In another aspect, generating a plurality of predictions that the disease event will happen within a future time period, further comprises an operation of generating four forecasts using Logistic Regression, AdaBoost, Decision Tree and Support Vector Machine, and then performing Bayesian Model Averaging to combine the four forecasts.

Finally, the invention also includes a method and computer program product. The method comprises acts of causing one or more processors to perform the operations listed herein, while the computer program product is, for example, a non-transitory computer readable medium having instructions encoded thereon for causing the one or more processors to perform the operations described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a prediction system according to the principles of the present invention;

FIG. 2 is an illustration of a computer program product according to the principles of the present invention;

FIG. 3 is an illustration providing a process flow for prediction of Hantavirus occurrences according to the principles of the present invention;

FIG. 4 is a chart illustrating historical Hantavirus activity level, e.g. events rates per month (5 weeks), vs. Hantavirus disease counts;

FIG. 5 is flow chart depicting a process for Enhanced Filter Signal (EFS) calculation for the dataset of N Google Trends (GT) and time series (TS);

FIG. 6 is a table comparing Pearson correlation coefficients between GT web searches and randomly generated time series;

FIG. 7 is a chart illustrating EFS and disease occurrence rates;

FIG. 8 is a chart illustrating prediction rates (one week ahead) obtained as a result of regression of EFS on Hantavirus incidences rates with sliding window of 52 weeks;

FIG. 9 is a table providing correlation coefficients for Hantavirus-related web-search terms;

FIG. 10 is an illustration providing Receiver Operating Characteristic (ROC) curves for random forest importance (RFI), Rank Correlation, and Information Gain;

FIG. 11 is an illustration depicting probabilities of predicted disease events as compared with actual events; and

FIG. 12 is a table illustrating results for real-time predictions according to the principles of the present invention.

### DETAILED DESCRIPTION

The present invention relates to a prediction system and, more particularly, to a system for predicting disease using open source data. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of incorporated literature references is provided. Next, a glossary of terms used in the description and claims is provided. Thereafter, a description of various principal aspects of the present invention is provided. Subsequently, an introduction provides the reader with a general understanding of the present invention. Finally, specific details of the present invention are provided to give an understanding of the specific aspects.

### (1) LIST OF INCORPORATED LITERATURE REFERENCES

The following references are cited throughout this application. For clarity and convenience, the references are listed herein as a central resource for the reader. The following references are hereby incorporated by reference as though fully included herein. The references are cited in the application by referring to the corresponding literature reference number.
1. Ginsberg, J., et al., Detecting influenza epidemics using search engine query data. Nature, 2009. 457(7232): p. 1012-U4.
2. Carneiro, H. A. and E. Mylonakis, Google Trends: A Web-Based Tolol for Real-Time Surveillance of Disease Outbreaks. Clinical Infectious Diseases, 2009. 49(10): p. 1557-1564.
3. Nsoesie, E. O., et al., A Simulation Optimization Approach to Epidemic Forecasting. Plos One, 2013. 8(6).
4. Pervaiz, F., et al., FluBreaks: Early Epidemic Detect ion from Google Flu Trends. Journal of Medical Internet Research, 2012. 14(5).
5. Polgreen, P. M., et al., Using Internet Searches for Influenza Surveillance. Clinical Infectious Diseases, 2008. 47(11): p. 1443-1448.
6. Wilson, K. and J. S. Brownstein, Early detection of disease outbreaks using the Internet. Canadian Medical Association Journal, 2009. 180(8): p. 829-831.
7. Zhou, X., J. Ye, and Y. Feng, Tuberculosis Surveillance by Analyzing Google Trends. Ieee Transactions on Biomedical Engineering, 2011. 58(8).
8. Althouse, B. M. Y. Y. Ng, and D. A. T. Cummings, Prediction of Dengue Incidence Using Search Query Surveillance. Plos Neglected Tropical Diseases, 2011. 5(8): p. e1258.
9. Chan, E. H., et al., Using Web Search Query Data to Monitor Dengue Epidemics: A New Model for Neglected Tropical Disease Surveillance. Plos Neglected Tropical Diseases, 2011. 5(5): p. e1206.
10. Tanner, L., et al., Decision Tree Algorithms Predict the Diagnosis and Outcome of Dengue Fever in the Early Phase of Illness. Plos Neglected Tropical Diseases, 2008. 2(3).
11. Samaras, L., E. Garcia-Barriocanal, and M.-A. Sicilia, Syndromic surveillance models using Web data: The caste of scarlet fever in the UK. Informatics for Health & Social Care, 2012. 37(2): p. 106-124.
12. Zhou, X., et al., Monitoring Epidemic Alert Levels by Analyzing Internet Search Volume. Ieee Transactions on Biomedical Engineering, 2013. 60(2): p. 446-452.
13. Markey, P. M. and C. N. Markey, Annual variation in Internet keyword searches: Linking dieting interest to obesity and negative health outcomes. Journal of Health Psychology, 2013. 18(7): p. 875-886.
14. Beauchemin, C. A. and A. Handel, A review of mathematical models of influenza A infections within a host or cell culture: lessons learned and challenges ahead BMC Public Health, 2011. 11 (suppl 1): p. S7.
15. Funk, S., M. Salath, and V. A. A. Jansen, Modelling the influence of human behaviour on the spread of infectious diseases: a review. 2010. 7: p. 1247-1256.
16. Murillo, L. N., M. S. Murillo, and A. S. Perelson, Towards multiscale modeling of influenza infection. Journal of Theoretical Biology, 2013. 332: p. 267-290.
17. Lipp, E. K., A. Huq, and R. R. Colwell, Effects of global climate on infectious disease: the cholera model. Clinical Microbiology Reviews, 2002. 15(4): p. 757.
18. McMichael, A. J., R. E. Woodruff, and S. Hales, Climate change and human health: present and future risks. Lancet, 2006. 367(9513): p. 859-869.
19. Patz, J. A., et al., Impact of regional climate change on human health. Nature, 2005. 438(7066): p. 310-317.
20. Barboza, P., et al., Evaluation of Epidemic intelligence Systems Integrated in the Early Alerting and Reporting Project for the Detection of A/H5N1 Influenza Events. Plos One, 2013. 8(3).
21. Dugas, A. F., Influenza Forecasting with Google Flu Trends.
22. Kang, M., et al., Using Google Trends for Influenza Surveillance in South China. Plos One, 2013. 8(1).
23. Malik, M. T., et al., “Google Flu Trends” and Emergency Department Triage Data Predicted the 2009 Pandemic H1N1 Waves in Manitoba. Canadian Journal of Public Health, 2011. 102(4): p. 294-297.
24. Hulth, A. and G. Rydevik, GET WELL: an automated surveillance system for gaining new epidemiological knowledge. Bmc Public Health, 2011. 11.

### (2) PRINCIPAL ASPECTS

The present invention has three “principal” aspects. The first is disease prediction system. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

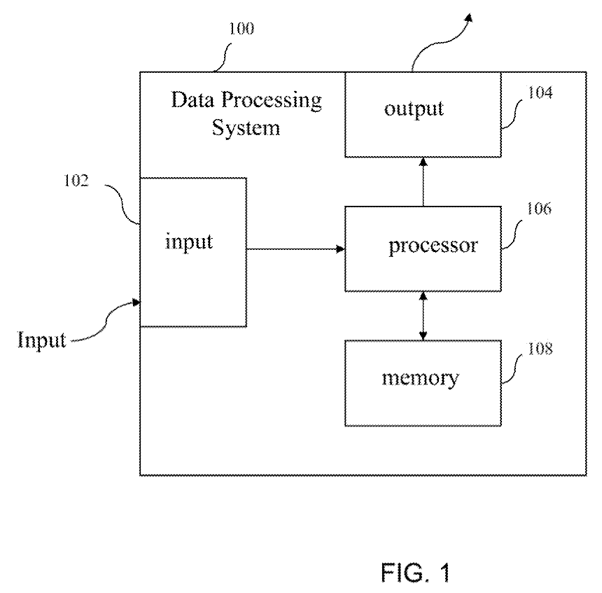

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, or a field programmable gate array.

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

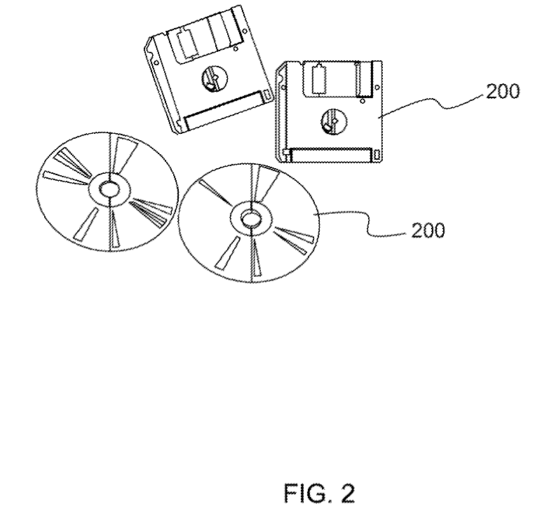

An illustrative diagram of a computer program product (i.e., storage device) embodying an aspect of the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of“instruction” include computer program code (source or object code) and “hard-coded” electronics (i.e. computer operations coded into a computer chip). The “instruction” may be stored in the memory of a computer or on a computer-readable medium such as a floppy disk, a CD-ROM, and a flash drive. In either event, the instructions are encoded on a non-transitory computer-readable medium.

### (3) INTRODUCTION

Described is a system and method for the prediction of incidences of rare disease, such as Hantavirus, based on keyword time series extracted from search engine (e.g., Google) search volumes (e.g., Google Trends (GT)). A unique aspect of this approach lays in: 1) the construction of an enhanced filtered signal (EFS) from social media source (e.g., GT), 2) the inclusion of this signal into a dataset used further in Machine Learning (ML), and 3) the application of the whole pipeline for prediction of disease (e.g., Hantavirus) occurrences. It is demonstrated that search activity in Google reflects the level of disease activity and can be used for prediction of rare disease events. Training of the system is performed, for example, on statistics for Hantavirus incidences obtained from the Ministries of Health websites.

The pipeline for Hantavirus prediction is designed to work with datasets which have a low signal-to-noise ratio (SNR); in other words, the signal related to Hantavirus morbidity trend is substantially contaminated with noise. As noted above, the pipeline includes an enhanced filtered signal which is based on linear correlation (Pearson correlation) and Bayesian model averaging (BMA) of Machine Learning techniques. These processes are complementary in the sense that they can capture different nature of dependencies between morbidity trends and web searches queries of disease-related terms.

The Enhanced Filtered Signal (EFS) is based on the idea of signal multiplication by summation of chosen search trends. The developers of Google Flu Trends (see Literature Reference No. 1) utilized this concept but in a different context than presented by the present application. Their criteria (i.e., the developers of Google Flu Trends) to choose how many trends to include for prediction relied on the results of one-sample-out cross-validation of testing data, and they have many of search times series highly correlated with ILI disease level (max R˜0.95). However, they did not implement machine learning methods for disease prediction.

The system addresses the need of surveillance and monitoring of the epidemiology and spreading of a virus, such as that of Hanta. The system provides a significant tool for the ministries of health and other health decision makers by serving as a complement to traditional surveillance systems in providing timely forecasts and reflecting the current state of disease spreading before the official statistics are published. The system can also be used to predict dengue, as the incidences of this pathogen can vary by a factor of ten in some settings. In summary, the system provides an analysis of correlation between signals characterizing human behaviors which result in prediction of future significant events (such as disease prediction). Notably, the system provides a considerable technical improvement over the prior art in that it effectively predicts disease events based on web search terms, even when there is a low-correlation between the disease trends and related search volume trends. Specific details are provided below.

### (4) SPECIFIC ASPECTS OF THE INVENTION

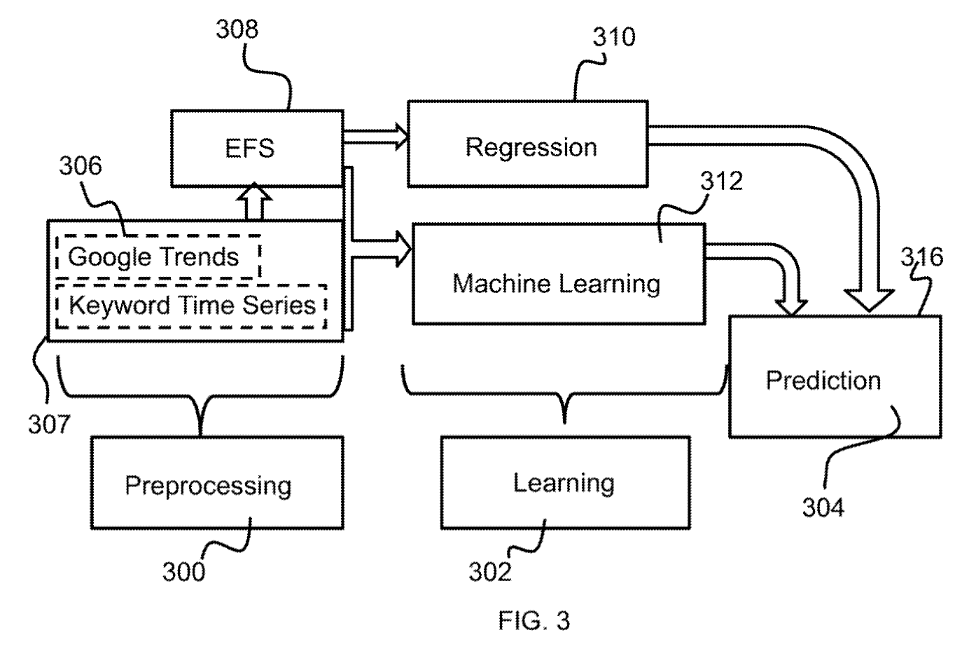

FIG. 3 provides a systematic view of the system for prediction of disease (e.g., Hantavirus outbreaks). As shown, the entire pipeline can be divided into three major modules: a preprocessing module 300, a learning module 302, and prediction module 304. The preprocessing module 300 provides the filtering of Google trends 306 and scaling. It also includes the computation of the EFS signal 308, which is obtained by adding of the time series 307 with highest absolute value of correlation coefficient. Time series 307 which have high negative correlation are added with a negative sign. The learning module 302 includes regression 310 and machine learning (ML) 312 where the EFS time series regressed on the times series of disease occurrences and the activity level is predicted based on the fit. The EFS signal 308 is added to data sets for Google Trends time series 306 and trained on ground truth, forecasts by the ML 312 process (e.g., four ML methods) are united using Bayesian Model Averaging. Activity level computed from the regression module 310 is combined with a prediction from ML 312. Briefly, if a number of occurrences of disease is large enough (e.g., greater than 5, or any other predetermined threshold number as desired), regression 310 is used; alternatively, if the number of occurrences is small (e.g., less than 5, or any other predetermined threshold number as desired), machine learning (ML) 312 is used. The EFS signal 308 provides the threshold to switch from regression 310 to ML 312. Specific details regarding each of these modules and processes are provided below.

It should be understood that although the system is described below with respect to the Hantavirus, it is not intended to be limited thereto as it can be applied to any disease for prediction purposes. Having said that and for illustrative purposes, the system was tested for Hantavirus prediction in Chile. Google Trends of disease-related terms were downloaded using API every week and are country specific. Terms were related to the name, treatment, symptoms of Hantavirus and other diseases. Official statistics of confirmed cases were obtained from the Ministry of Health website, found at epi.minsal.cl/informe-situacion-epidemiologica-hantavirus-3/for Chile; bulletins at that site are updated weekly with no delay. Since official reports started in the year of 2008, data analysis was conveyed starting in the year of 2008.

### (4.1) PREPROCESSING MODULE—ENHANCED FILTERED SIGNAL (EFS)

As noted above, the system includes a preprocessing module that provides the filtering of Google trends and scaling, which is used to generate the EFS signal. Social interest for events and reaction of society is reflected in Google Trends. This property is used to build a surveillance system for monitoring different aspects of social life, including diseases. The formation of Google Trends is a complicated process subject to influence of many aspects and factors. In general, a trend of interest may be represented using convolution of time series of events and some social response functions, as follows:

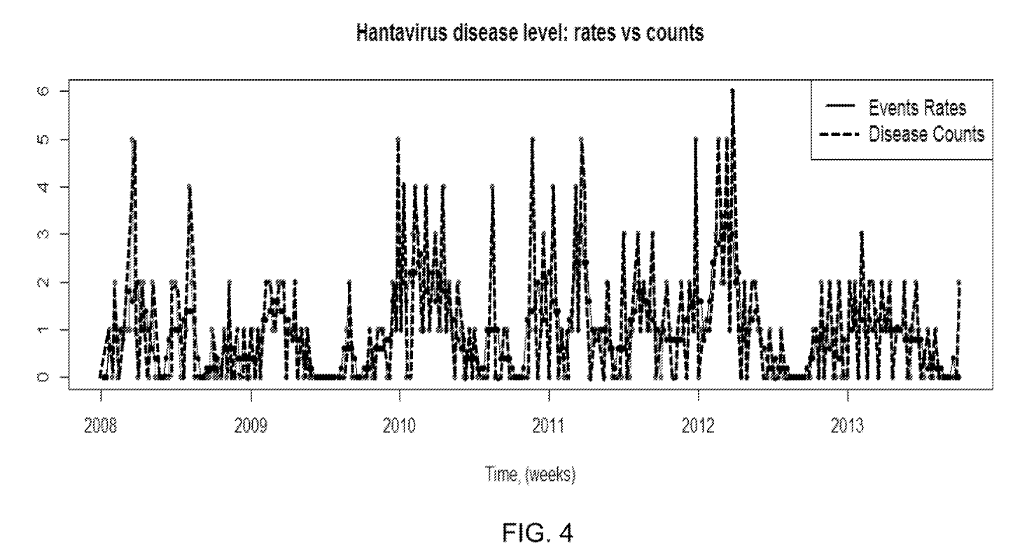

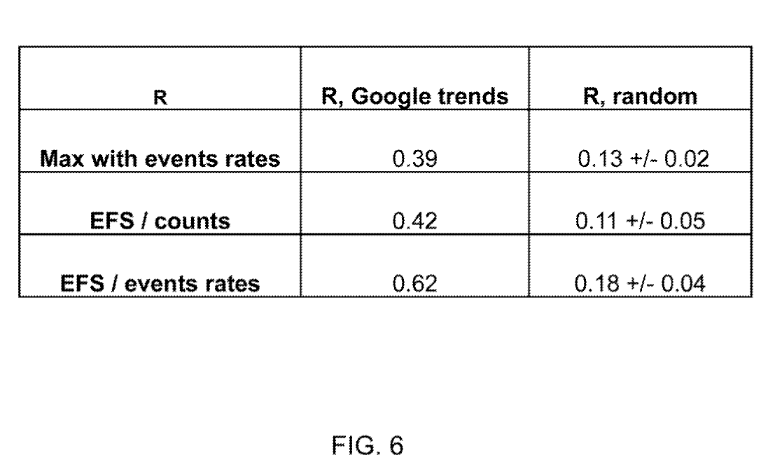

GT_{E}≈Eₜₛ [symbol] φₛ,

where GT_{E} is a trend of interest, Eₜₛ are relevant events, and φₛ is a social response function, which can be presented as a Gaussian function (asymmetric or symmetric) with standard deviation proportional to the lifetime of the event. Some of the events (such as Hantavirus incidences) can be discussed in the new source of social media (e.g., Google trends) before the case confirmation, and can also have post-history, depending on the impact of the event on the society. Because the social response function (φₛ) is unknown and very difficult to estimate, it is replaced with the curve representing events rates, calculated as a moving average with a five week time window, which is shifted backward by two weeks to avoid the lag (as shown in FIG. 4). FIG. 4, for example, provides a graph that illustrates Hantavirus activity level, showing the event rates per month versus the Hantavirus disease counts. Rate is the number of disease occurrence per some period of time (N/t); in this case number of disease counts (occurrences) per month. Thus, instead of using a correlation of Google trends with events themselves, the system according to the principles of the present invention performs the analysis using events rates curves for correlation. As shown in the table provided in FIG. 6, disease related trends show much higher correlation with events rates, than with events occurrences (i.e., counts).

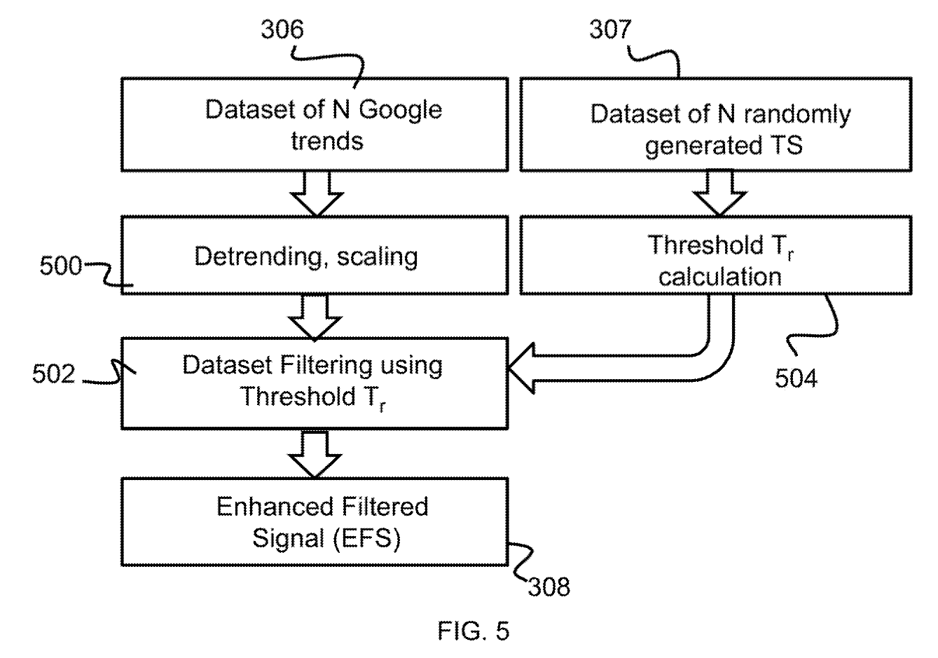

The process as implemented by the preprocessing module (for determining the EFS 308) is illustrated in FIG. 5. Specifically, FIG. 5 is a flowchart illustrating the process for EFS 308 calculation for the dataset of N Google Trends (GT) 306 and time series (TS) 307. The system starts with dataset of NGoogle Trends 306 for disease-related terms. Google Trends is a public web facility of Google Inc., based on Google Search, that shows how often a particular search-term is entered relative to the total search-volume across various regions of the world. It should be noted that the use of Google Trends is for illustrative purposes only as the invention is not intended to be limited thereto and can be operated using any service that catalogs search term usage and volume, generically referred to as “trend results”. Thereafter, detrending and scaling 500 in is performed. In other words, trend is removed due to the increased number of usage of internet, with the data then rescaled to be in the range from 0 to 100. Detrending due to the increased internet usage is done routinely, for example, by researchers when Google trends are used for disease tracking and predictions (see Literature Reference Nos. 1, 2, 5, 6, 7, and 11). In this non-limiting example, detrending done with fast Fourier transform (FFT), so the 0 frequency was removed from an initial time series. After that, scaling of data from 0 to 1 was performed.

The system then performs dataset filtering 502 to remove signals unrelated to occurrences of the searched event (e.g., Hantavirus infection). To remove such unrelated signals, the system first determines a threshold 504 for a Pearson correlation coefficient by performing the steps of: (1) generating the same number of random time series as in the GT dataset; (2) if the GT dataset contains M points, the number in the range from 0 to 100 is randomly picked M times so the length of each time series is the same as in the original set; (3) calculating the maximum Pearson Correlation coefficient R between the ground truth and each of a random trend; (4) repeating steps (1), (2), and (3) a sufficiently large number of times (e.g., 100 times); 5) filtering the dataset such that the mean of the obtained distribution of R is a threshold Tᵣ used for the dataset filtering: where only time series which have R>Tᵣ are summed together and form the EFS. In the presented study, for example, Tᵣ=0.14.

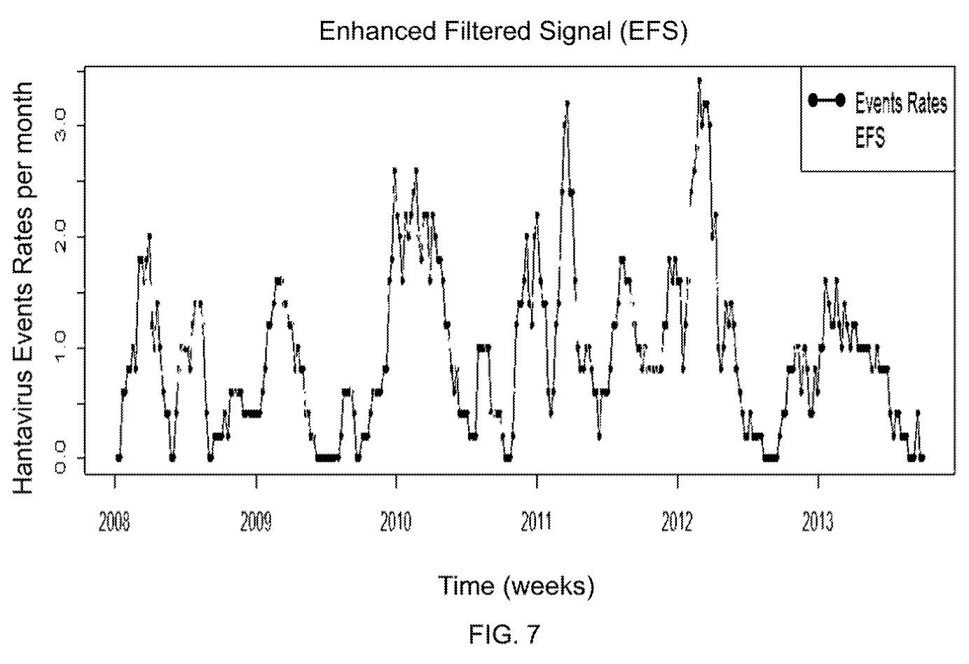

For illustrative purposes, FIG. 7 provides a plot of the EFS signal as calculated for Chile's web-searches (R=0.62). Dynamics of morbidity of Hantavirus has seasonal cycles, with two peaks: the weak one is in winter and the stronger one is in summertime reaching five to six confirmed cases per week. A hantavirus related search shows a high correlation with morbidity trends.

### (4.2) LEARNING MODULE—REGRESSION OF EFS ON TIME SERIES OF HANTAVIRUS INCIDENCES AND MACHINE LEARNING OF GOOGLE TRENDS TIME SERIES ON TIME SERIES OF HANTAVIRUS INCIDENCES

As noted above, the system includes a learning module that provides regression and machine learning (ML). Several classified learning techniques are employed to predict if the Hantavirus incidence will happen (e.g., whether or not the incidence will happen within the next week). As noted above, Hantavirus counts are relatively low as compared to others disease; thus, predicting disease activity level with an EFS curve allows the system to approximately predict the average number of cases, while the ML methods determine if the event will happen (e.g., next week) or not.

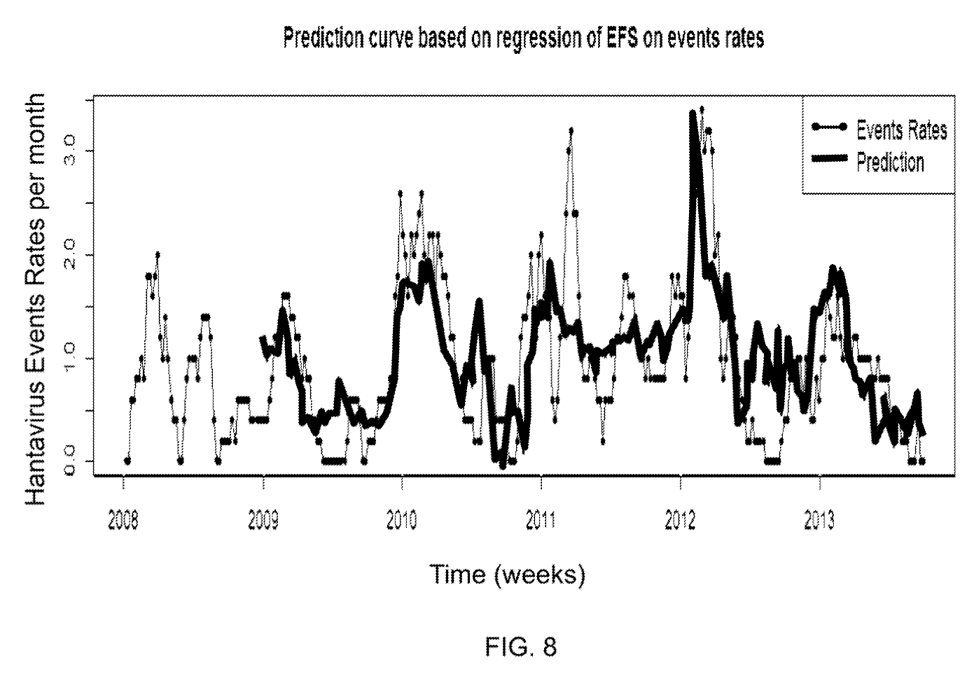

The regression of EFS allows the system to accurately forecast how many events may happen next week. For example, FIG. 8 is a graph showing linear regression of the curve on event rates with a 52 weeks sliding window. Specifically, FIG. 8 depicts predictions of event rates (thick line) that is adjusted ahead one week (or any other predetermined time period) as a result of regression of the EFS on Hantavirus incidence rates with a sliding window of 52 weeks.

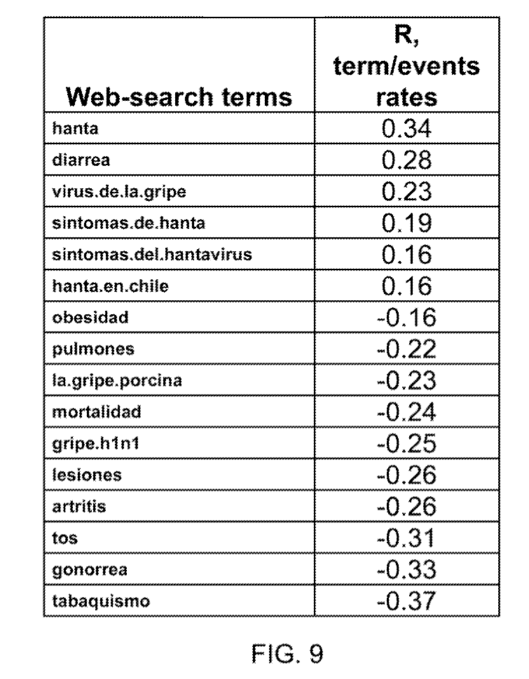

It should be noted what queries are the most relevant to Hantavirus activity. For example, FIG. 9 is a table of web search terms with values of highest correlation coefficients for Chile. As expected, names of Hantavirus and its symptoms are among the most highly correlated queries, while queries for other diseases have large negative correlation. In general, values of Pearson coefficients are much smaller than those demonstrated by researchers for other diseases, such as influenza or dengue fever, which is explained by relatively small number of people having had the disease; as a result, web searches are much noisier.

As noted above, ML methods determine if the event will happen (e.g., next week) or not. Historical datasets are used for analysis and training. As a non-limiting example and for the results described herein, data from January 2010 through October 2013 was analyzed, with the training period being January 2010 through October 2012. Four ML techniques are used, all of which are known to those skilled in the art, including Logistic Regression (LR), AdaBoost (AB), Decision Tree (DT) and Support Vector Machine (SVM). Bayesian Model Averaging (BMA) is then used to combine the four forecasts. R packages—“glm”, “ada”, “rpart”, “svm” and “bms”, were used for analysis. As understood by those skilled in the art, the aforementioned packages are commonly understood names of packages for R, which, in this case, were used for ML.

The following features constituted the analyzed dataset:
a. Web-search queries of Hantavirus related terms are collected and filtered to account for increased number of internet users;
b. An EFS curve was added to the dataset;
c. The time series was shifted by one week forward to account for the preceding information; and
d. Momentums of time series were generated (raw, shifted and EFS). Momentums are difference between two consecutive points in time series that are uses to account for changes in keywords counts.

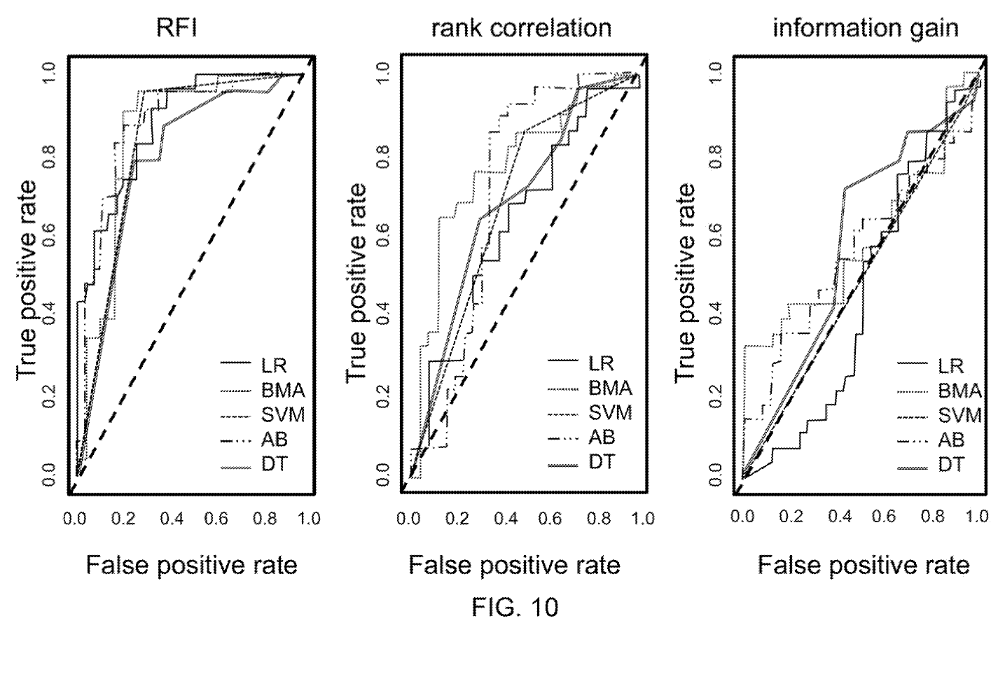

Several feature selection criteria can be applied in order to get rid of noisy and irrelevant features. Non-limiting examples of such feature selection criteria include linear correlation, rank correlation, information based criteria's and random forest importance (RFI) criteria as they are implemented in “FSelector” package (R). For each feature selection criteria, an ML analysis is performed with a different number of selected features (from ˜150 to 2), followed by Principal Component Analysis (PCA) for dimensionality reduction. To demonstrate performance, shown in FIG. 10 are the best ROC curves that were obtained for the training datasets, with each model's parameters estimated for the training dataset. All techniques show similar behavior in terms of accuracy and other performance evaluation metrics. The best performance is observed if only four to five features are left after applying a random forest importance (RFI) filter.

It should be noted that in this example, the EFS curve that has the highest score among all features is calculated using RFI criteria.

### (4.3) PREDICTION MODULE—REAL TIME PREDICTION FOR HANTAVIRUS INCIDENCES IN CHILE

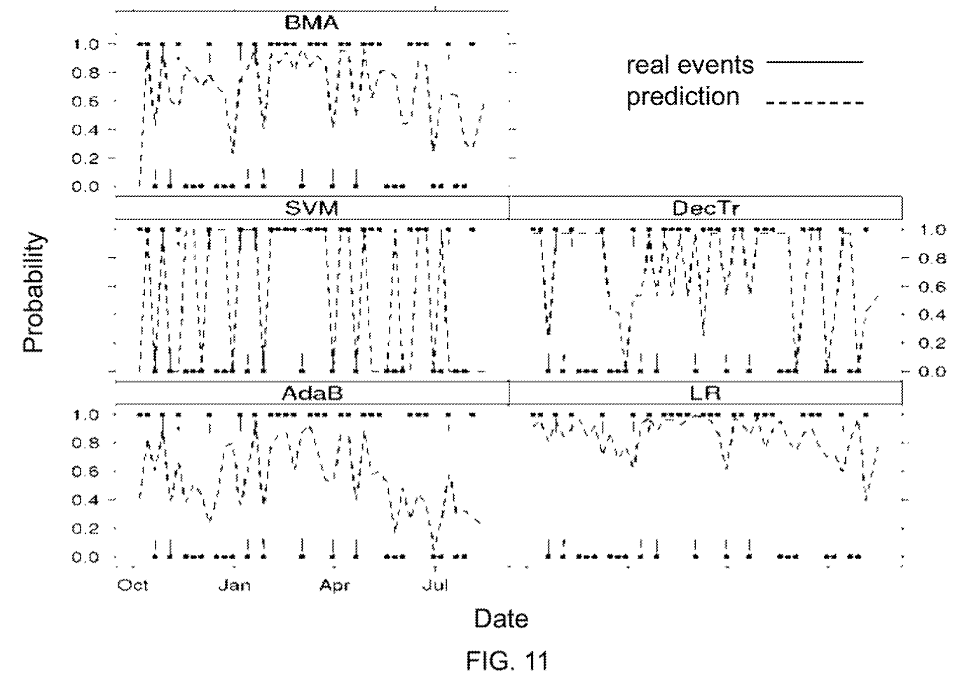

As noted above, the system incorporates a prediction module that generates a likelihood or probability that a disease event will occur within a future time period (e.g., the next week). The probabilities (i.e., prediction) of events to happen as estimated by the four ML techniques and BMA are illustrated in FIG. 11 alongside the real events. In other words, if an actual event happened (i.e., real event), the historical probability is 1, whereas if it did not happen, the historical probability is 0. As shown, the BMA curve has a reasonably high correlation with the sequence of real events. The threshold for the probability value with the best performance can be estimated; which, for example, is approximately 0.6, with recall of approximately 0.72 and precision of approximately 0.87. It should be noted that in many instances, the prediction peaks of the BMA curve co-occur with peaks of the real events curve. One can draw a line for different probability values and calculate how many times the peaks of the two curves coincide. After that, precision and recall are calculated. Computation of precision and recall is done automatically for different values of probabilities. Thereafter, a probability value with the best pair precision/recall is chosen to provide prediction results.

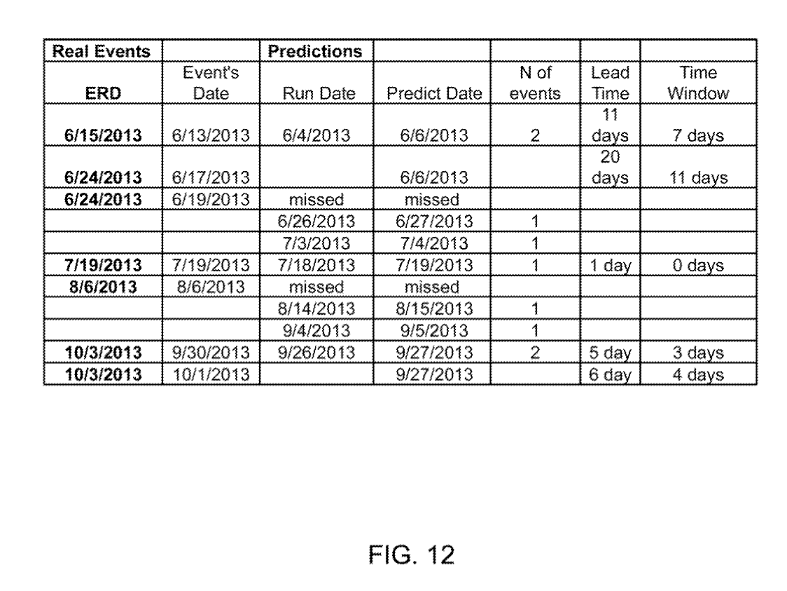

The system described herein was used for real time prediction of cases of Hantavirus in Chile. The system was run every week to estimate the probability of an event to happen next week; each time the system was run, the last fifty weeks were provided as the testing period to estimate the probability threshold based on the best performance criteria. The results are presented in the table as illustrated in FIG. 12 (for the period from June 2013 up to the beginning of October 2013). The date of a case confirmation is considered as an event date. The Earliest Reported Date (ERD) is the date that a bulletin is published by the Chilean Ministry of Health (which publishes weekly bulletins of cases). The time window is the number of days between the date when a prediction was made (i.e., Run Date in the table) and the event's date. Even though an event date is considered as a date of case confirmation, evolution of one specific disease history can take a long time: these cases often happen in rural areas and first symptoms can appear two to four weeks before the case is officially confirmed. Taking this into account, the time window can be increased (e.g., up to 14 days) for a forecast to be marked as correct. Only cases forecasted at least one day before the ERD and happening within the time window (e.g., fourteen day time window) are considered as valid predictions. The column ‘N of days’ shows the estimation of number of events to happen (i.e., the prediction made from activity level analysis based on regression of the EFS curve). For example, if in the last four weeks only two events occurred and there is a prediction of one for activity level—it means that three events will happen (activity level is calculated as a number of events in five weeks). As shown in the table, seven events occurred and the system correctly predicted five of them (“missed” two). Nine forecasts were made; thus, the recall in this example is 0.71 and precision 0.56. The number of days between the run date and event date (lead time) constituted on average 6.6 days, with the time window on average being 4.8 days.

### (4.4) CONCLUSION

In summary, described is a unique disease prediction system that provides a considerable technical improvement over the prior art in that it effectively predicts disease events based on web search terms, even when there is a low-correlation between the disease trends and related search volume trends (as opposed to the prior art that requires a high-correlation). The system as described above requires a detailed sequence of methods and techniques used for EFS calculation and ML analysis, which allows for forecasting and real time predictions of Hantavirus incidences. The EFS curve is generated based on the summation of a time series containing a signal of interest to increase the signal-to-noise ratio (SNR). Regression of this curve on an events rates curve is used for evaluation of activity level. Forecasts of Machine Learning techniques combined using BMA are probabilities of event/no event will occur next week. If the ML prediction exceeds a threshold, it is estimated how many of events will happen based on the activity level obtained using the EFS curve and issue the forecast. The whole system was tested in real time for prediction of Hantavirus incidences in Chile, which demonstrated acceptable performance levels with a recall of 0.71 and a precision of 0.56.

1. A disease prediction system using open source data, the system comprising:
one or more processors and a memory, the memory being a non-transitory computer readable medium having executable instructions encoded thereon, such that upon execution of the instructions, the one or more processors perform operations of:
receiving, in a preprocessing module, a dataset of N trend results related to a disease event in a population and generating an enhanced filter signal (EFS) curve related to the disease event, wherein the N trend results are received from an internet based public web facility and reflect how often a particular search-term related to the disease event is entered relative to a total search-volume across a population;
receiving, in a learning module, the EFS curve and generating a predicted number of cases of the disease event and, using a plurality of machine learning methods, generating a plurality of predictions that the disease event will happen within a future time period; and
determining, with a prediction module, precision and recall for each of the plurality of predictions and, based on the precision and recall, providing a likelihood that the disease event will occur in the population.

2. The system as set forth in claim 1, wherein in generating the EFS curve, the preprocessing module further performs operations of detrending, scaling, and filtering the dataset to remove signals unrelated to occurrences of the searched disease event.

3. The system as set forth in claim 2, wherein in filtering the dataset, the dataset is filtered with a threshold for a Pearson coefficient.

4. The system as set forth in claim 3, wherein in filtering the dataset, the preprocessing module determines the threshold for a Pearson coefficient by performing operations of:
generating a same number of random time series as in the dataset of N trend results;
if the dataset of N trend results contains M points, randomly picking a number in a range from 0 to 100 M times so that a length of each time series is the same;
calculating a maximum Pearson Correlation coefficient R between a ground truth and each of a random trend;
repeating the operations of generating, randomly picking, and calculating a predetermined number of times; and
filtering the dataset of N trend results such that a mean of the distribution of R is a threshold Tᵣ used for dataset filtering, such that only time series which have R>Tᵣ are summed together and form the EFS.

5. The system as set forth in claim 4, wherein in providing a likelihood that the disease event will occur, the prediction amongst the plurality of predictions that provides a best precision/recall pair is selected as the likelihood that the disease event will occur.

6. The system as set forth in claim 5, wherein generating a predicted number of cases of the disease event, further comprises an operation of performing linear regression on the EFS curve with a sliding window that is adjusted ahead a predetermined time period.

7. The system as set forth in claim 6, wherein generating a plurality of predictions that the disease event will happen within a future time period, further comprises an operation of generating four forecasts using Logistic Regression, AdaBoost, Decision Tree and Support Vector Machine, and then performing Bayesian Model Averaging to combine the four forecasts.

8. A method for disease prediction using open source data, the method comprising an act of:
causing one or more processors to execute code stored on a non-transitory computer readable medium, such that upon execution, the one or more processors perform operations of:
receiving, in a preprocessing module, a dataset of N trend results related to a disease event in a population and generating an enhanced filter signal (EFS) curve related to the disease event, wherein the N trend results are received from an internet based public web facility and reflect how often a particular search-term related to the disease event is entered relative to a total search-volume across a population;
receiving, in a learning module, the EFS curve and generating a predicted number of cases of the disease event and, using a plurality of machine learning methods, generating a plurality of predictions that the disease event will happen within a future time period; and
determining, with a prediction module, precision and recall for each of the plurality of predictions and, based on the precision and recall, providing a likelihood that the disease event will occur in the nopulation.

9. The method as set forth in claim 8, wherein in generating the EFS curve, the preprocessing module further performs operations of detrending, scaling, and filtering the dataset to remove signals unrelated to occurrences of the searched disease event.

10. The method as set forth in claim 9, wherein in filtering the dataset, the dataset is filtered with a threshold for a Pearson coefficient.

11. The method as set forth in claim 10, wherein in filtering the dataset, the preprocessing module determines the threshold for a Pearson coefficient by performing operations of:
generating a same number of random time series as in the dataset of N trend results;
if the dataset of N trend results contains M points, randomly picking a number in a range from 0 to 100 M times so that a length of each time series is the same;
calculating a maximum Pearson Correlation coefficient R between a ground truth and each of a random trend;
repeating the operations of generating, randomly picking, and calculating a predetermined number of times; and
filtering the dataset of N trend results such that a mean of the distribution of R is a threshold Tᵣ used for dataset filtering, such that only time series which have R>Tᵣ are summed together and form the EFS.

12. The method as set forth in claim 11, wherein in providing a likelihood that the disease event will occur, the prediction amongst the plurality of predictions that provides a best precision/recall pair is selected as the likelihood that the disease event will occur.

13. The method as set forth in claim 12, wherein generating a predicted number of cases of the disease event, further comprises an operation of performing linear regression on the EFS curve with a sliding window that is adjusted ahead a predetermined time period.

14. The method as set forth in claim 13, wherein generating a plurality of predictions that the disease event will happen within a future time period, further comprises an operation of generating four forecasts using Logistic Regression, AdaBoost, Decision Tree and Support Vector Machine, and then performing Bayesian Model Averaging to combine the four forecasts.

15. A computer program product for disease prediction using open source data, the computer program product comprising:
a non-transitory computer-readable medium having executable instructions encoded thereon, such that upon execution of the instructions by one or more processors, the one or more processors perform operations of:
receiving, in a preprocessing module, a dataset of N trend results related to a disease event in a population and generating an enhanced filter signal (EFS) curve related to the disease event, wherein the N trend results are received from an internet based public web facility and reflect how often a particular search-term related to the disease event is entered relative to a total search-volume across a population;
receiving, in a learning module, the EFS curve and generating a predicted number of cases of the disease event and, using a plurality of machine learning methods, generating a plurality of predictions that the disease event will happen within a future time period; and
determining, with a prediction module, precision and recall for each of the plurality of predictions and, based on the precision and recall, providing a likelihood that the disease event will occur in the population.

16. The computer program product as set forth in claim 15, wherein in generating the EFS curve, the preprocessing module further performs operations of detrending, scaling, and filtering the dataset to remove signals unrelated to occurrences of the searched disease event.

17. The computer program product as set forth in claim 16, wherein in filtering the dataset, the dataset is filtered with a threshold for a Pearson coefficient.

18. The computer program product as set forth in claim 17, wherein in filtering the dataset, the preprocessing module determines the threshold for a Pearson coefficient by performing operations of:
generating a same number of random time series as in the dataset of N trend results;
if the dataset of N trend results contains M points, randomly picking a number in a range from 0 to 100 M times so that a length of each time series is the same;
calculating a maximum Pearson Correlation coefficient R between a ground truth and each of a random trend;
repeating the operations of generating, randomly picking, and calculating a predetermined number of times; and
filtering the dataset of N trend results such that a mean of the distribution of R is a threshold Tᵣ used for dataset filtering, such that only time series which have R>Tᵣ are summed together and form the EFS.

19. The computer program product as set forth in claim 18, wherein in providing a likelihood that the disease event will occur, the prediction amongst the plurality of predictions that provides a best precision/recall pair is selected as the likelihood that the disease event will occur.

20. The computer program product as set forth in claim 19, wherein generating a predicted number of cases of the disease event, further comprises an operation of performing linear regression on the EFS curve with a sliding window that is adjusted ahead a predetermined time period.

21. The computer program product as set forth in claim 20, wherein generating a plurality of predictions that the disease event will happen within a future time period, further comprises an operation of generating four forecasts using Logistic Regression, AdaBoost, Decision Tree and Support Vector Machine, and then performing Bayesian Model Averaging to combine the four forecasts.
